(19) United States
(12) Patent Application Publication
(10) Pub. No.: US 2015/0293413 A1
(43) Pub. Date: Oct. 15, 2015

(54) THIN-FILM TRANSISTOR ARRAY SUBSTRATE AND LIQUID CRYSTAL DISPLAY DEVICE

(71) Applicant: SHARP KABUSHIKI KAISHA, Osaka-shi, Osaka (JP)

(72) Inventors: Iori AOYAMA, Osaka-shi (JP); Yuichi KITA, Osaka-shi (JP); Takatomo YOSHIOKA, Osaka-shi (JP); Takao IMAOKU, Osaka-shi (JP); Yoshiki NAKATANI, Osaka-shi (JP)

(73) Assignee: Sharp Kabushiki Kaisha, Osaka-shi, Osaka (JP)

(21) Appl. No.: 14/647,457

(22) PCT Filed: Nov. 26, 2013
(86) PCT No.: PCT/JP2013/081691

§ 371 Date: May 27, 2015

(30) Foreign Application Priority Data
Dec. 3, 2012 (JP) 2012-264397

(51) Int. Cl. G02F 1/1343; G02F 1/1368

(52) U.S. Cl. CPC G02F 1/134309; G02F 1/13439; G02F 1/1368

(57) ABSTRACT

The present invention provides a thin-film transistor array substrate capable of sufficiently preventing a decrease in the aperture ratio and insufficient charging of thin-film transistor elements due to shortening of signal writing time for pixels while achieving high speed driving; and a liquid crystal display device including the thin-film transistor array substrate. The thin-film transistor array substrate of the present invention includes thin-film transistor elements; first and second gate bus lines extending in a first direction; and first and second source bus lines extending in a second direction that intersects the first direction, the thin-film transistor elements arranged in the second direction including a first thin-film transistor element connected to the first gate bus line and the first source bus line, and a second thin-film transistor element connected to the second gate bus line and the second source bus line, the first or second source bus line including a first division site or a second division site that divides the first source bus line or the second source bus line into two lines connected to different source drivers, and is in a region where the first or second source bus line overlaps the second or first gate bus line.

### TECHNICAL FIELD

The present invention relates to a thin-film transistor array substrate and a liquid crystal display device. More specifically, the present invention relates to a thin-film transistor array substrate suitable for a display device that employs a system such as a field sequential system and thus requires a high speed response; and a liquid crystal display device including the thin-film transistor array substrate.

### BACKGROUND ART

Thin-film transistor array substrates can turn the display on or off by electrically controlling devices such as a display device, and are commonly used as substrates for sandwiching a liquid crystal layer in a liquid crystal display device, for example. In recent years, thin-film transistor array substrates are widely used in applications such as electronic books, picture frames, industrial appliances (IAs), personal computers (PCs), tablet PCs, and smartphones. For these applications, liquid crystal display devices in various modes related to electrode arrangements and the designs of substrates for achieving a high speed response have been studied, and examples thereof include the following.

Patent Literature 1, for example, discloses a thin film transistor liquid crystal display having a high speed response and wide viewing angle, including: a first substrate with a first common electrode layer; a second substrate with both a pixel electrode layer and a second common electrode layer; liquid crystal between the first substrate and the second substrate; and means for generating an electric field between the first common electrode layer in the first substrate and both the pixel electrode layer and the second common electrode layer in the second substrate so that the display provides the high speed response to high input data rates and allows for wide viewing angles for viewers.

Patent Literature 2, for example, discloses a liquid crystal device including a pair of substrates consisting of a first substrate and a second substrate facing each other, and a liquid crystal layer sandwiched between the substrates and containing liquid crystal with positive anisotropy of dielectric constant, the first substrate and the second substrate provided with an electrode, the electrodes that face each other with the liquid crystal layer in between and apply a vertical electric field to the liquid crystal layer, the second substrate including multiple electrodes that applies a horizontal electric field to the liquid crystal layer.

### CITATION LIST

### Patent Literature

### Patent Literature 1: JP 2006-523850 T

### Patent Literature 2: JP 2002-365657 A

### SUMMARY OF INVENTION

### Technical Problem

As described above, liquid crystal display devices have been desired to provide a high speed response. A liquid crystal display device, however, may not be able to sufficiently provide a high speed response if the arrangement of bus lines (gate bus lines and source bus lines) is not optimal in the thin-film transistor array substrate. This is because as the driving frequency of the liquid crystal display device increases, the signal writing time for pixels (hereinafter, simply referred to as writing time) is shortened, and as a result, charging of thin-film transistor elements may be significantly insufficient. Such insufficient charging occurs particularly when the device includes a large-sized liquid crystal display panel (when the load on the conductive lines such as gate bus lines and source bus lines is large) or a high definition liquid crystal display panel (when the number of bus lines is large; for example, in the case of a quad full high definition (QFHD) liquid crystal display panel).

For example, this phenomenon is described with reference to a conventional liquid crystal display device 201 illustrated in FIG. 14. FIG. 14 is a schematic plan view illustrating a conventional liquid crystal display device.

As illustrated in FIG. 14, the conventional liquid crystal display device 201 includes gate drivers 203a and 203b, and a source driver 204, around a display region 202. The gate drivers 203a and 203b input scanning signals to thin-film transistor elements (e.g. thin-film transistor elements 207) which are provided in the display region 202. The source driver 204 inputs image signals to the thin-film transistor elements. The display region 202 may be a display region of a liquid crystal display panel in the liquid crystal display device 201, or may be a drive region (active region) of a thin-film transistor array substrate in the liquid crystal display device 201.

The gate drivers 203a and 203b are arranged at the respective two sides, facing each other, of the four sides of the display region 202. The source driver 204 is arranged at one of the four sides of the display region 202 other than the two sides at which the gate drivers 203a and 203b are arranged.

The display region 202 includes gate bus lines 205 (those indicated by broken lines extending in the right-left direction of FIG. 14 and connected to the gate drivers 203a and 203b) which are driven by the gate drivers 203a and 203b, and source bus lines 206 (those indicated by solid lines extending in the up-down direction of FIG. 14 and connected to the source driver 204) which are driven by the source driver 204. Here, the gate bus lines 205 and the source bus lines 206 overlap each other at the intersections thereof in a plan view of the main surface of the display region 202.

Usually, in the case of image signals for televisions, a one-frame image is transmitted at 60 Hz. For example, when the conventional liquid crystal display device 201 displays a one-frame image by dividing the image into three sub-frames of red (R), green (G), and blue (B) (which is the case of the field sequential system described later), the driving frequency of the liquid crystal display device 201 is 180 Hz.

The case of increasing the driving frequency from 60 Hz to 120 Hz in the liquid crystal display device 201 illustrated in FIG. 14 is described. In the case of increasing the driving frequency from 60 Hz to 120 Hz, the number of the gate bus lines 205 performing writing for each of the source bus lines 206 can be halved by employing a double source structure, and as a result, the writing time can be equivalent to the writing time in the case that the driving frequency is 60 Hz. Here, the double source structure refers to a structure that enables simultaneous writing for each two pixels along the individual source bus lines 206 (simultaneous writing is performed for each two of the gate bus lines 205).

For example, a liquid crystal display device has a structure as illustrated in FIG. 15 if the device has a three-layered electrode structure capable of controlling the alignment of liquid crystal molecules by an electric field in both rising [period in which the display state changes from a dark state (black display) to a bright state (white display)] and falling [period in which the display state changes from a bright state (white display) to a dark state (black display)], and switches between turning on of a vertical electric field (electric field applied in the direction perpendicular to the main surface of the thin-film transistor array substrate in falling) and turning on of a horizontal electric field (electric field applied in the direction parallel to the main surface of the thin-film transistor array substrate) (the switching is also referred to as an ON-ON switching mode). FIG. 15 is an enlarged schematic plan view of one portion of the display region illustrated in FIG. 14 in an ON-ON switching mode liquid crystal display device. The thin solid lines, thick solid lines, thin broken lines, and thick broken lines, each extending in the up-down direction of FIG. 15, indicate source bus lines, and correspond to solid lines extending in the up-down direction of FIG. 14. In FIG. 15, the symbols “+(plus)” and “− (minus)” indicate the polarities of voltages output from the source driver 204, for example. Also, the solid lines and broken lines extending in the up-down direction of FIG. 15 are intended to clearly show the borders between pixels (for example, different lines are used for a pixel 210a and a pixel 210c).

As illustrated in FIG. 15, since an ON-ON switching mode liquid crystal display device includes three thin-film transistor elements per pixel, the device includes six source bus lines per pixel when the device has a double source structure. Here, the double source structure in the ON-ON switching mode liquid crystal display device is a structure enabling simultaneous writing for the pixels 210a and 210b, for example.

Next, a case is described in which the driving frequency is increased to 180 Hz so that the display device is driven at an even higher speed. For a liquid crystal display device with a driving frequency increased to 180 Hz, it is possible to provide sufficient writing time compared to a display device with a driving frequency of 120 Hz, by increasing the number of the source bus lines 206, thereby increasing the number of pixels for which writing is simultaneously performed (the number of the gate bus lines 205 performing simultaneous writing). However, further increasing the number of the source bus lines 206 decreases the aperture ratio of the liquid crystal display device. For this reason, the liquid crystal display device can still be improved in terms of sufficiently preventing a decrease in the aperture ratio and insufficient charging of thin-film transistor elements due to shortening of signal writing time for pixels.

Patent Literature 1 says that it achieves a high speed response by rotating liquid crystal molecules by electric fields, namely a fringe electric field generated between the pixel electrode layer and the second common electrode layer in the second substrate in rising, and a vertical electric field generated by an electric potential difference between the substrates in falling. Patent Literature 1, however, does not teach any appropriate arrangement of bus lines in terms of increasing the driving frequency, and thus the technique can still be improved to solve the above problems.

Patent Literature 2 says that it provides a liquid crystal device exhibiting an increased response speed without causing an increase in the manufacturing process or manufacturing cost, a projection display device and an electronic device with the liquid crystal device. However, Patent Literature 2 does not teach any appropriate arrangement of bus lines in terms of increasing the driving frequency, and thus the technique can still be improved to solve the above problems.

The present invention has been made in view of the above current state of the art, and aims to provide a thin-film transistor array substrate capable of sufficiently preventing a decrease in the aperture ratio and insufficient charging of thin-film transistor elements due to shortening of signal writing time for pixels while achieving high speed driving; and a liquid crystal display device including the thin-film transistor array substrate.

### Solution to Problem

The present inventors have made various studied on a thin-film transistor array substrate capable of sufficiently preventing a decrease in the aperture ratio and insufficient charging of thin-film transistor elements due to shortening of signal writing time for pixels while achieving high speed driving; and a liquid crystal display device including the thin-film transistor array substrate. As a result, the present inventors have focused on use of multiple source drivers in a double source structure. The present inventors have thereby found that by dividing the source bus lines into two lines and dividing the lines at optimum sites, a decrease in the aperture ratio can be sufficiently prevented while sufficient writing time is provided. Consequently, the present inventors have solved the above problems, completing the present invention.

That is, in one aspect, the present invention may be a thin-film transistor array substrate including: thin-film transistor elements; first and second gate bus lines extending in a first direction; and first and second source bus lines extending in a second direction that intersects the first direction, the thin-film transistor elements arranged in the second direction including a first thin-film transistor element connected to the first gate bus line and the first source bus line, and a second thin-film transistor element connected to the second gate bus line and the second source bus line, the first source bus line including a first division site that divides the first source bus line into two lines connected to different source drivers, and is in a region where the first source bus line overlaps the second gate bus line, the second source bus line including a second division site that divides the second source bus line into two lines connected to different source drivers, and is in a region where the second source bus line overlaps the first gate bus line.

The thin-film transistor array substrate in the above one aspect of the present invention is not particularly limited by other components, and may appropriately employ other components typically used for thin-film transistor array substrates.

In another aspect, the present invention may be a liquid crystal display device including the thin-film transistor array substrate.

The liquid crystal display device in the above other aspect of the present invention is not particularly limited by other components, and may appropriately employ other components typically used for liquid crystal display devices.

### Advantageous Effects of Invention

In aspects, the present invention can provide a thin-film transistor array substrate capable of sufficiently preventing a decrease in the aperture ratio and insufficient charging of thin-film transistor elements due to shortening of signal writing time for pixels while achieving high speed driving; and a liquid crystal display device including the thin-film transistor array substrate.

### BRIEF DESCRIPTION OF DRAWINGS

FIG. 1 is a schematic plan view of a liquid crystal display device including a thin-film transistor array substrate of any one of Embodiment 1, Embodiment 2, and Embodiment 3.

FIG. 2 is an enlarged schematic plan view of one portion of the display region illustrated in FIG. 1.

FIG. 3 is a schematic plan view of a thin-film transistor array substrate in an ON-ON switching mode liquid crystal display device.

FIG. 4 is a schematic cross-sectional view of a pixel portion of a liquid crystal display panel in an ON-ON switching mode liquid crystal display device.

FIG. 5 is a schematic view illustrating display unevenness caused by different luminance levels of pixels.

FIG. 6 is a schematic plan view illustrating non-preferred division sites of source bus lines.

FIG. 7 is an enlarged schematic plan view of the vicinity of a thin-film transistor element illustrated in FIG. 6.

FIG. 8 is a schematic plan view illustrating another non-preferred division site of a source bus line.

FIG. 9 is a schematic plan view illustrating favorable division sites of source bus lines.

FIG. 10 is a schematic plan view illustrating a liquid crystal display device of Embodiment 1.

FIG. 11 is a schematic view illustrating the case where a site at which scanning regions are discontinuous is not generated.

FIG. 12 is a schematic view illustrating the case where a site at which scanning regions are discontinuous is generated.

FIG. 13 is a schematic plan view illustrating a liquid crystal display device of Embodiment 3.

FIG. 14 is a schematic plan view illustrating a conventional liquid crystal display device.

FIG. 15 is an enlarged schematic plan view of one portion of the display region illustrated in FIG. 14 in an ON-ON switching mode liquid crystal display device.

### DESCRIPTION OF EMBODIMENTS

Preferred aspects of the thin-film transistor array substrate of the present invention are described below.

In one aspect of the thin-film transistor array substrate of the present invention, the second gate bus line overlapping the first division site may be adjacent to the first gate bus line overlapping the second division site.

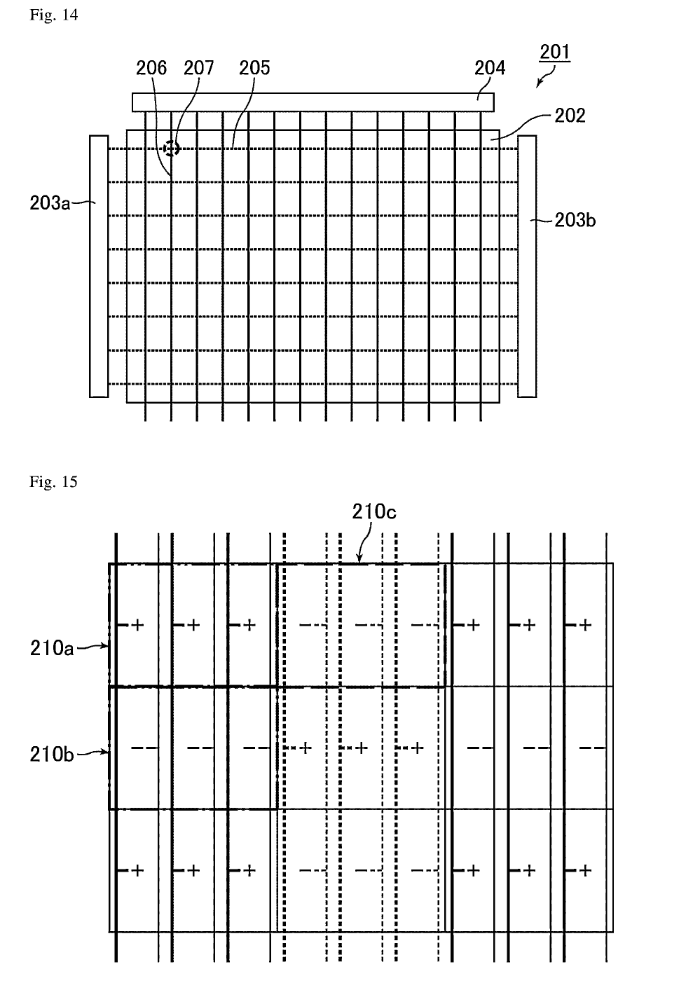

Thereby, the writing time can be sufficiently provided, and the writing time can be about doubled at most, compared to the case of employing a double source structure with one source driver 204 as illustrated in FIG. 14 and FIG. 15. Accordingly, insufficient charging of thin-film transistor elements due to shortening of writing time can be sufficiently prevented while high speed driving is achieved.

In another aspect of the thin-film transistor array substrate of the present invention, the second gate bus line overlapping the first division site may not be adjacent to the first gate bus line overlapping the second division site.

Thereby, the writing time can be sufficiently provided compared to the case of employing a double source structure with one source driver 204 as illustrated in FIG. 14 and FIG. 15. Accordingly, insufficient charging of thin-film transistor elements due to shortening of writing time can be sufficiently prevented while high speed driving is achieved.

In yet another aspect of the thin-film transistor array substrate of the present invention, the first and second division sites may be arranged to divide a drive region of the thin-film transistor array substrate into two regions in the first direction, and the divided two regions in the drive region of the thin-film transistor array substrate may include the same number of gate bus lines.

Thereby, the numbers of gate bus lines that perform writing (hereinafter, also referred to as the numbers of scanning lines) are the same in the divided two regions in the drive region of the thin-film transistor array substrate, and the writing time can be about doubled compared to the case of employing a double source structure with one source driver 204 as illustrated in FIG. 14 and FIG. 15. Accordingly, insufficient charging of thin-film transistor elements due to shortening of writing time can be sufficiently prevented while high speed driving is achieved.

The “the divided two regions in the drive region of the thin-film transistor array substrate” refers to two drive regions (display regions) such as, for example in FIG. 1, a region AR1 including the parts of source bus lines 6a and 6b which are formed by dividing the source bus lines 6a and 6b into two lines at the division sites 8a and 8b and connected to a source driver 4a; and a region AR2 including the parts of the source bus lines 6a and 6b which are formed by dividing the source bus lines 6a and 6b into two lines at the division sites 8a and 8b and connected to a source driver 4b.

In yet another aspect of the thin-film transistor array substrate of the present invention, the first and second division sites may be arranged to divide a drive region of the thin-film transistor array substrate into two regions in the first direction, and the divided two regions in the drive region of the thin-film transistor array substrate may include different numbers of gate bus lines.

Thereby, the writing time can be sufficiently provided compared to the case of employing a double source structure with one source driver 204 as illustrated in FIG. 14 and FIG. 15. Accordingly, insufficient charging of thin-film transistor elements due to shortening of writing time can be sufficiently prevented while high speed driving is achieved.

In yet another aspect of the thin-film transistor array substrate of the present invention, the thin-film transistor elements may include a semiconductor layer that contains an oxide semiconductor.

Oxide semiconductors characteristically have a higher mobility and smaller property dispersion than amorphous silicon. For this reason, a thin-film transistor element containing an oxide semiconductor can be driven at a higher speed, has a higher driving frequency, and occupies a smaller proportion of one pixel than a thin-film transistor element containing amorphous silicon, and is thus more suitable for the driving of next-generation display devices with a higher definition. Also, an oxide semiconductor film is formed by a more simple process than a polycrystalline silicon film, and thus is advantageously applicable to devices which require a film to be formed in a large area. Therefore, in the case that the thin-film transistor elements in one aspect of the thin-film transistor array substrate of the present invention includes a semiconductor layer containing an oxide semiconductor, a decrease in the aperture ratio and insufficient charging of thin-film transistor elements due to shortening of writing time can be sufficiently prevented while further high speed driving is achieved.

The oxide semiconductor may be, for example, IGZO (In—Ga—Zn—O) consisting of indium (In), gallium (Ga), zinc (Zn), and oxygen (O); ITZO (In-Tin-Zn—O) consisting of indium (In), tin (Sn), zinc (Zn), and oxygen (O); or IAZO (In—Al—Zn—O) consisting of indium (In), aluminum (Al), zinc (Zn), and oxygen (O).

The above aspects may be appropriately combined as long as the combination does not go beyond the scope of the present invention.

In the following, preferred aspects of the liquid crystal display device of the present invention are described.

In one aspect of the liquid crystal display device of the present invention, the liquid crystal display device may include the thin-film transistor array substrate; a counter substrate facing the thin-film transistor array substrate; and a liquid crystal layer sandwiched between the thin-film transistor array substrate and the counter substrate, the thin-film transistor array substrate including a first electrode, a second electrode, and a third electrode, the counter substrate including a fourth electrode, the first electrode and the second electrode constituting a pair of comb-teeth electrodes that include line portions and are arranged on the liquid crystal layer side relative to the third electrode, the third electrode and the fourth electrode each being a planar electrode.

Thereby, in an ON-ON switching mode liquid crystal display device, a decrease in the aperture ratio and insufficient charging of thin-film transistor elements due to shortening of writing time can be sufficiently prevented while high speed driving is achieved.

In another aspect of the liquid crystal display device of the present invention, the device may align liquid crystal molecules, contained in the liquid crystal layer, in a direction perpendicular to the main surfaces of the thin-film transistor array substrate and the counter substrate when no voltage is applied.

Such a vertical alignment liquid crystal display device is advantageous in achieving properties such as a wide viewing angle and a high contrast. Hence, in the case that the liquid crystal display device in one aspect of the present invention is a vertical alignment liquid crystal display device, a decrease in the aperture ratio and insufficient charging of thin-film transistor elements due to shortening of writing time can be sufficiently prevented while high speed driving is achieved. Also, in this case, a wide viewing angle and a high contrast can be achieved. Here, the phrase “when no voltage is applied” refers to any state where voltage is considered not to be substantially applied in the art of the present invention. Also, the phrase “aligns . . . in a direction perpendicular to the main surfaces of the thin-film transistor array substrate and the counter substrate” refers to any alignment considered to be made in a direction perpendicular to the main surfaces of the thin-film transistor array substrate and the counter substrate in the art of the present invention, including an alignment made in the substantially perpendicular direction.

In yet another of the liquid crystal display device of the present invention, the first electrode and the second electrode constituting a pair of comb-teeth electrodes may be formed in the same layer. The first electrode and the second electrode constituting a pair of comb-teeth electrodes may be formed in different layers as long as they can achieve the effects in the aspects of the present invention. Here, the phrase “the first electrode and the second electrode constituting a pair of comb-teeth electrodes may be formed in the same layer” means that these comb-teeth electrodes are in contact with a common component (e.g. insulating layer and/or liquid crystal layer) on the liquid crystal layer side and/or the side opposite to the liquid crystal layer side.

In yet another aspect of the liquid crystal display device of the present invention, the thin-film transistor array substrate may further include an insulating layer, and the insulating layer may be on the side opposite to the liquid crystal layer side of each of the first electrode and the second electrode.

Here, a horizontal electric field (electric field generated in the direction parallel to the main surfaces of the thin-film transistor array substrate and the counter substrate) can be suitably generated between the pair of comb-teeth electrodes including multiple line portions (between the first electrode and the second electrode). Here, the phrase “electric field generated in the direction parallel to the main surfaces of the thin-film transistor array substrate and the counter substrate” refers to any electric field considered to be generated in a direction parallel to the main surfaces of the thin-film transistor array substrate and the counter substrate in the art of the present invention, including an electric field generated in the substantially parallel direction. Also, a fringe electric field can be suitably generated between the comb-teeth electrodes (the first electrode and the second electrode) and the third electrode having a planar shape.

The third electrode and the fourth electrode, which have a planar shape, can suitably generate a vertical electric field (electric field generated in the direction perpendicular to the main surfaces of the thin-film transistor array substrate and the counter substrate) between the thin-film transistor array substrate including the third electrode and the counter substrate including the fourth electrode. Here, the phrase “electric field generated in the direction perpendicular to the main surfaces of the thin-film transistor array substrate and the counter substrate” refers to any electric field considered to be generated in a direction perpendicular to the main surfaces of the thin-film transistor array substrate and the counter substrate in the art of the present invention, including an electric field generated in the substantially perpendicular direction.

Therefore, the horizontal electric field (or fringe electric field) and a vertical electric field as described above can be suitably generated.

In yet another aspect of the liquid crystal display device of the present invention, the liquid crystal display device may be driven by a field sequential system.

The field sequential system is a mode that provides multicolor display without color filters by switching the colors (e.g. R, G, and B) of the light sources in the liquid crystal display device at a high speed to mix the colors. Usually, image signals for televisions are transmitted at 60 Hz, and in the case of utilizing the field sequential system, image display is provided by dividing a one-frame image into three sub-frames of, for example, R, G, and B. That is, the liquid crystal display device is driven at a driving frequency of 180 Hz.

Here, as mentioned above, the ON-ON switching mode liquid crystal display device has a three-layered structure in which the alignment of liquid crystal molecules is controlled by an electric field in both rising and falling, and the device switches between turning on of the vertical electric field and turning on of the horizontal electric field. The device is therefore compatible with the field sequential system that requires a high speed response (for example, switching, synchronously with switching of the colors of the light sources, the displays corresponding to the respective colors at a high speed). Accordingly, when one aspect of the liquid crystal display device of the present invention is an ON-ON switching mode liquid crystal display device driven by the field sequential system, a decrease in the aperture ratio and insufficient charging of thin-film transistor elements due to shortening of writing time can be sufficiently prevented while high speed driving is achieved.

Also, in the preferred aspects of the liquid crystal display device of the present invention, the thin-film transistor array substrate in any of the preferred aspects of the present invention may be employed.

The above aspects may be appropriately combined as long as the combination does not go beyond the scope of the present invention.

The present invention will be described in more detail below with reference to the drawings based on embodiments which, however, are not intended to limit the scope of the present invention. Also, the configurations in the following embodiments may be appropriately combined as long as the combination does not go beyond the scope of the present invention.

The basic structure of the thin-film transistor array substrate of any of the embodiments includes thin-film transistor elements, gate bus lines, and source bus lines. The liquid crystal display device of any of the embodiments includes, in addition to the thin-film transistor array substrate of any of the embodiments, gate drivers adapted to input scanning signals to the thin-film transistor elements, and source drivers adapted to input image signals to the thin-film transistor elements. The gate bus lines are driven by the gate drivers, and the source bus lines are driven by the source drivers.

### Embodiment 1

The liquid crystal display device that can suitably employ a thin-film transistor array substrate of Embodiment 1 (hereinafter, also referred to the liquid crystal display device of Embodiment 1) is described below. The liquid crystal display device of Embodiment 1 is a vertical alignment ON-ON switching mode liquid crystal display device in which the second gate bus line overlapping the first division site is adjacent to the first gate bus line overlapping the second division site, the first and second division sites are arranged to divide the drive region of the thin-film transistor array substrate into two regions in the first direction, and the divided two regions in the drive region of the thin-film transistor array substrate include the same number of gate bus lines.

FIG. 1 is a schematic plan view of a liquid crystal display device including the thin-film transistor array substrate of Embodiment 1. As illustrated in FIG. 1, a liquid crystal display device 1 includes gate drivers 3a and 3b and the source drivers 4a and 4b around a display region 2. The gate drivers 3a and 3b are each adapted to input scanning signals to the thin-film transistor elements (e.g. thin-film transistor elements 7a and 7b) arranged in the display region 2. The source drivers 4a and 4b are each adapted to input image signals to the thin-film transistor elements. The display region 2 may be a display region of a liquid crystal display panel in the liquid crystal display device 1, or may be a drive region (active region) of the thin-film transistor array substrate in the liquid crystal display device 1.

The gate drivers 3a and 3b are arranged at the respective two sides, facing each other, of the four sides of the display region 2. The source drivers 4a and 4b are arranged at the respective two sides, facing each other, of the four sides of the display region 2 other than the above two sides at which the gate drivers 3a and 3b are arranged.

The display region 2 includes gate bus lines (those indicated by broken lines extending in the right-left direction of FIG. 1 and connected to the gate drivers 3a and 3b) which are driven by the gate drivers 3a and 3b, and source bus lines (those indicated by solid lines extending in the up-down direction of FIG. 1 and connected to the source drivers 4a and 4b) which are driven by the source drivers 4a and 4b. Here, the gate bus lines and the source bus lines overlap each other at the intersections thereof in a plan view of the main surface of the display region 2.

As illustrated in FIG. 1, the gate bus lines include gate bus lines 5a and 5b, and the source bus lines include the source bus lines 6a and 6b. The thin-film transistor elements arranged in the up-down direction of FIG. 1 (direction in which the source bus lines 6a and 6b extend) include thin-film transistor elements 7a and 7b. The thin-film transistor element 7a is connected to the gate bus line 5a and the source bus line 6a. The thin-film transistor element 7b is connected to the gate bus line 5b and the source bus line 6b.

Also, the source bus line 6a includes a division site 8a that is in a region where the source bus line 6a overlaps the gate bus line 5b in a plan view of the main surface of the display region 2. The source bus line 6b includes a division site 8b that is in a region where the source bus line 6b overlaps the gate bus line 5a in a plan view of the main surface of the display region 2. Here, the division sites 8a and 8b are regions where the thin-film transistor elements are not arranged. The source bus line 6a is divided, at the division site 8a, into two lines connected to different source drivers, namely 4a and 4b. The source bus line 6b is divided, at the division site 8b, into two lines connected to different source drivers, namely 4a and 4b. The display region 2 includes the region AR1 including the parts of the source bus lines 6a and 6b which are formed by dividing the source bus lines 6a and 6b into two lines at division sites 8a and 8b and connected to the source driver 4a; and the region AR2 including the parts of the source bus lines 6a and 6b which are formed by dividing the source bus lines 6a and 6b into two lines at the division sites 8a and 8b and connected to the source driver 4b. As illustrated in FIG. 1, the display region 2 has the same structure as described above, including the gate bus lines 5a and 5b, the source bus lines 6a and 6b, the thin-film transistor elements 7a and 7b, and the division sites 8a and 8b.

The right-left direction and the up-down direction of FIG. 1 correspond to the respective first and second directions in the aspects of the present invention. The gate bus lines 5a and 5b respectively correspond to the first and second gate bus lines in the aspects of the present invention. The source bus lines 6a and 6b respectively correspond to the first and second source bus lines in the aspects of the present invention. The thin-film transistor elements 7a and 7b respectively correspond to the first and second thin-film transistor elements in the aspects of the present invention. The division sites 8a and 8b respectively correspond to the first and second division sites in the aspects of the present invention.

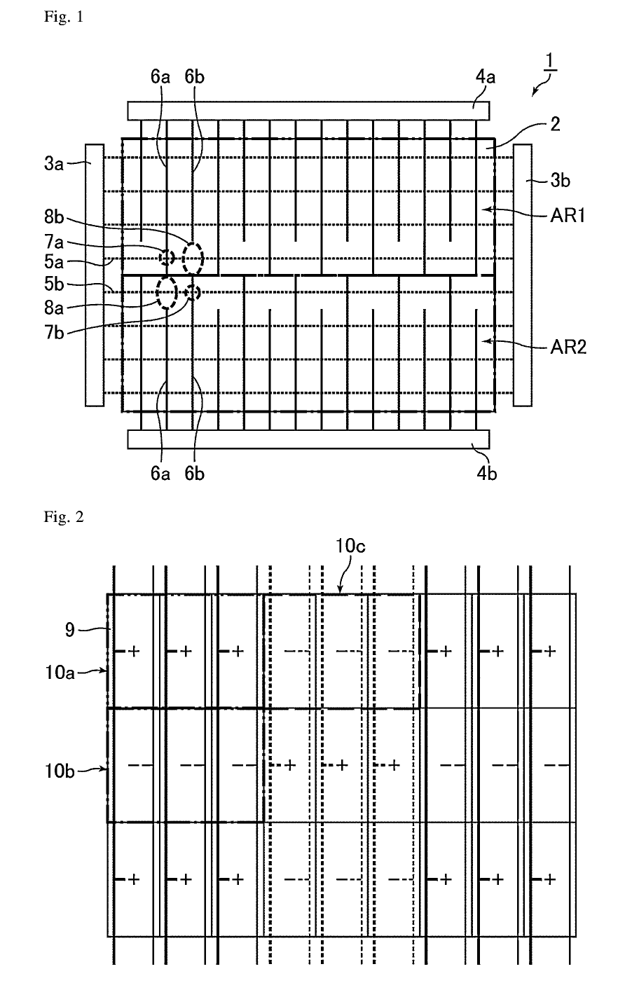

FIG. 2 is an enlarged schematic plan view of one portion of the display region illustrated in FIG. 1, which is an enlarged view of one portion of a region without division sites (e.g. division sites 8a and 8b) of the source bus lines (e.g. source bus lines 6a and 6b) in FIG. 1. The thin solid lines, thick solid lines, thin broken lines, and thick broken lines, each extending in the up-down direction of FIG. 2, indicate source bus lines, and correspond to solid lines extending in the up-down direction of FIG. 1. In FIG. 2, the symbols “+(plus)” and “− (minus)” indicate the polarities of voltages output from the source driver 4a (source driver 4b), for example.

In the case that a liquid crystal display device including the individual thin-film transistor elements, one per pixel, has a double source structure, the device includes one electrode 9 per pixel, and two source bus lines per column of pixels as illustrated in FIG. 2. Here, the double source structure in a liquid crystal display device including the individual thin-film transistor elements, one per pixel, refers to a structure enabling simultaneous writing for, for example, a pixel provided with the electrode 9 and a pixel arranged adjacent to the above pixel in the down direction of FIG. 2.

An ON-ON switching mode liquid crystal display device includes three thin-film transistor elements per pixel, which means that the device includes three of the electrodes 9 per pixel, and three of the source bus lines per column of pixels. Here, in the case that the device also has a double source structure, the device includes six source bus lines per column of pixels as illustrated in FIG. 2. The double source structure in the ON-ON switching mode liquid crystal display device refers to a structure enabling simultaneous writing for, for example, pixels 10a and 10b. In FIG. 2, the solid lines and broken lines in the up-down direction as described above are intended to clearly show the borders between pixels in the ON-ON switching mode liquid crystal display device (for example, different lines are used for the pixel 10a and a pixel 10c). Also, the electrodes 9 are aligned in the up-down direction and the right-left direction of FIG. 2, and this alignment is drawn to clearly show that three of the electrodes 9 are provided per pixel in the ON-ON switching mode liquid crystal display device.

The ON-ON switching mode liquid crystal display device is compatible with the field sequential system as described above. Now, the case of employing the field sequential system in an ON-ON switching mode liquid crystal display device is described below.

In the case of employing the field sequential system, the ON-ON switching mode liquid crystal display device is driven at a driving frequency of 180 Hz as described above. For example, in the case of driving the liquid crystal display device at a driving frequency of 180 Hz and employing a single source structure (the system of performing writing for pixels, one by one, along a source bus line), the writing time per gate bus line is 1/(180×L) sec (=1 sec/180 Hz/[the number L of gate bus lines]), which is ⅓ of the writing time (1/[60×L] sec) in the case of driving the liquid crystal display device at a driving frequency of 60 Hz and employing a single source structure. Therefore, sufficient charging time for the thin-film transistor elements cannot be obtained.

Also, when a liquid crystal display device is driven at a driving frequency of 180 Hz or higher in the field sequential system, the display may have problems that “flickers” are recognized or the phenomenon of “color breakup” occurs.

The “flickers” are described. As described above, in the field sequential system, an image is displayed by dividing one-frame image for which signals have been transmitted at 60 Hz into three sub-frames of R, G, and B, which means that the device is driven at a driving frequency of 180 Hz. Among the luminance levels of R, G, and B, the luminance level of G is higher than the luminance levels of R and B. Accordingly, in the case of switching the displays corresponding to the colors at a high speed, the luminance level changes in the display corresponding to the colors (change from a lower luminance level [R] to a higher luminance level [G], and change from a high luminance level [G] to a lower luminance level [B]) appear as a luminance cycle which corresponds to 1/60 seconds (=1 sec/60 Hz). This cycle appears as a flicker on the display. Such a “flicker” can be made less recognizable by further increasing the driving frequency (e.g. by increasing the driving frequency to 240 Hz or to 300 Hz). This is because the increase shortens the luminance cycle (for example, the cycle is shortened to 1/80 seconds or to 1/100 seconds).

The “color breakup” is described. The “color breakup” is a phenomenon that the outlines of moving objects are colored in movie display, for example. The “color breakup” cannot be made less recognizable by simply increasing the driving frequency, differently from the “flickers”. The “color breakup” can be made less recognizable by interpolating images of the frame (hereinafter, also referred to as “frame interpolation”) and by backlight dimming for reducing “color breakup”, for example. Here, in the case of using frame interpolation and backlight dimming for reduction of “color breakup”, the driving frequency is increased.

Thereby, “flickers” and “color breakup” can be made less recognizable by further increasing the driving frequency to a frequency higher than 180 Hz. However, in the case of further increasing the driving frequency to a frequency higher than 180 Hz (for example, increasing the driving frequency to 240 Hz or to 300 Hz), the writing time is further shortened (for example, shortened to 1/[240×L] sec or to 1/[300×L]), and sufficient charging time for the thin-film transistor elements cannot be obtained.

Such insufficient charging of the thin-film transistor elements described above may be eliminated by increasing the channel lengths of the thin-film transistor elements, thereby increasing the amount of electron injection. However, increasing the channel lengths of the thin-film transistor elements is not preferred because it leads to an increase in the size of the thin-film transistor elements which decreases the aperture ratio.

Also, it is preferred that the thin-film transistor elements include a semiconductor layer containing the oxide semiconductor from the viewpoints of an increase in the amount of electron injection and reduction in the scale of the thin-film transistor elements. However, in the case that the device includes a high-definition or large-sized liquid crystal display panel, the load on the conductive lines is large, and thus it is difficult to achieve a sufficient charging ratio for the liquid crystal display panel using the thin-film transistor elements in consideration of the liquid crystal capacity.

Here, in an ON-ON switching mode liquid crystal display device, the writing time in the case of driving the device at a driving frequency of 180 Hz and employing a double source structure is 1/(90×L) sec (=1 sec/180 Hz/[L/2]), which gives longer charging time for the thin-film transistor elements compared to the writing time in the case of driving the device at a driving frequency of 180 Hz and employing a single source structure.

The polarity of the voltage to be output from the source driver 4a (source driver 4b) is now described. In the case of the source bus lines as illustrated in FIG. 2, the double source structure enables line inversion driving that inverts the polarity for the individual source bus lines. Accordingly, the line inversion driving can reduce the load on the source driver 4a (source driver 4b) compared to the dot inversion driving that inverts the polarity of the individual pixels arranged along one source bus line.

Therefore, in the case of employing the field sequential system in the ON-ON switching mode liquid crystal display device, the double source structure is suitable.

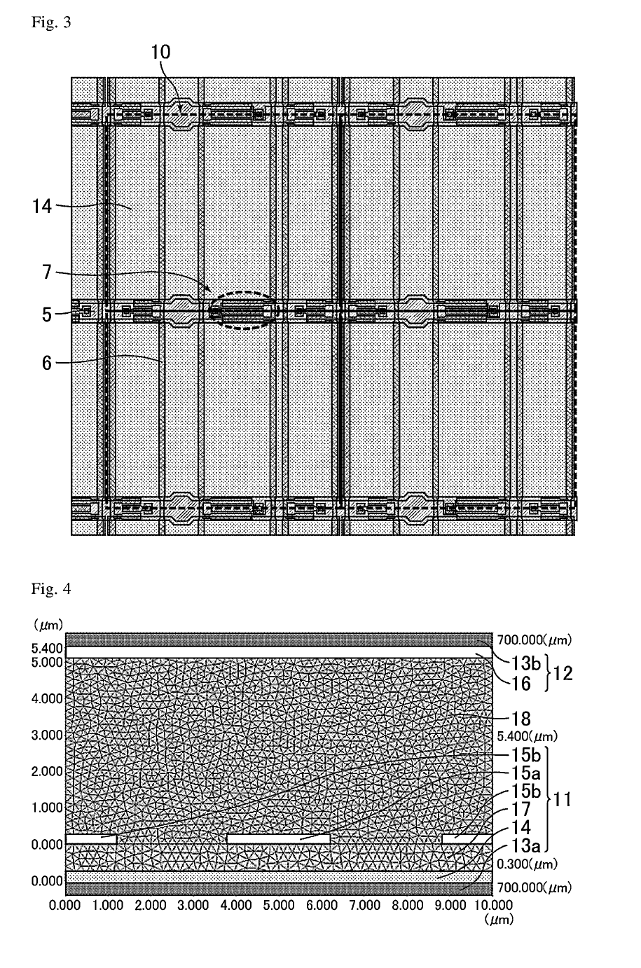

The structure of the ON-ON switching mode liquid crystal display device is described with reference to FIG. 3 and FIG. 4.

FIG. 3 is a schematic plan view of a thin-film transistor array substrate in an ON-ON switching mode liquid crystal display device. As illustrated in FIG. 3, the pixels 10 are each provided with three of the thin-film transistor elements 7 each of which is connected to one of the gate bus lines 5 and one of the source bus lines 6. Also, the pixels 10 each include upper electrodes (not illustrated) constituting a pair of comb-teeth electrodes as described below, and a planar lower electrode 14.

FIG. 4 is a schematic cross-sectional view of a pixel portion of a liquid crystal display panel in an ON-ON switching mode liquid crystal display device. As illustrated in FIG. 4, the liquid crystal display panel includes a thin-film transistor array substrate 11, a counter substrate 12, and a liquid crystal layer 18 sandwiched between the substrates.

The thin-film transistor array substrate 11 includes a glass substrate 13a; the lower electrode 14 formed on the liquid crystal layer 18 side of the glass substrate 13a; an insulating layer 17 formed on the liquid crystal layer 18 side of the lower electrode 14; and upper electrodes 15a and 15b constituting a pair of comb-teeth electrodes which are formed on the liquid crystal layer 18 side of the insulating layer 17. Here, the lower electrode 14 and the upper electrodes 15a and 15b are transparent electrodes formed from indium tin oxide (ITO) or indium zinc oxide (IZO), for example. The upper electrodes 15a and 15b are formed in the same layer. The insulating layer 17 may be an organic insulating film or an inorganic insulating film.

The counter substrate 12 includes a glass substrate 13b, and a planar counter electrode 16 formed on the liquid crystal layer 18 side of the glass substrate 13b. Here, the counter electrode 16 is a transparent electrode formed from ITO or IZO, for example.

The upper electrodes 15a and 15b respectively correspond to the first and second electrodes in the aspects of the present invention. The lower electrode 14 corresponds to the third electrode of the aspects of the present invention. The counter electrode 16 corresponds to the fourth electrode of the aspects of the present invention.

Usually, a liquid crystal display panel may include auxiliary capacitors arranged in parallel with the liquid crystal capacitors related to display. The auxiliary capacitors provide compensation for unevenness relative to the display qualities, and aids for the charging ratio during storage.

The ON-ON switching mode liquid crystal display device is designed to include lower electrodes (e.g. lower electrode 14) in openings excluding regions corresponding to bus lines (e.g. gate bus lines 5 and source bus lines 6) in order to increase the aperture ratio from the viewpoint of pixel layout. Also, the thin-film transistor elements can be decreased in size, and the aperture ratio can be increased when the thin-film transistor elements (e.g. thin-film transistor elements 7) include semiconductor layers containing an oxide semiconductor. Therefore, in the ON-ON switching mode liquid crystal display device, it is difficult to form auxiliary capacitors in parallel with the liquid crystal capacitors (e.g. capacitance between the upper electrodes 15a and 15b) related to display, and the metal conductive lines arranged within a pixel (e.g. pixel 10) may consist of a gate bus line (e.g. gate bus line 5) and a source bus line (e.g. source bus line 6).

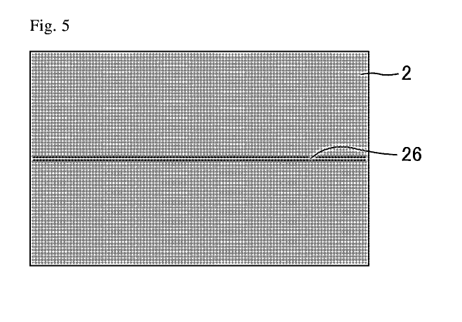

In the liquid crystal display device having a double source structure, when two source drivers are arranged (e.g. source drivers 4a and 4b) and image signals are input from the two sides of the liquid crystal display panel (e.g. display region 2) facing each other, the source bus lines can be divided into two lines. Here, the state where the division sites at which the source bus lines are divided into two lines are in the openings is not preferred from the viewpoint of display qualities. This is because the luminance levels of display are different between pixels including the division sites in the openings and pixels not including the division sites in the openings, and the difference in the luminance level may be recognized as display unevenness. For example, a pixel including a division site in the opening has a higher luminance by about 0.4% in the case of a resolution of 100 pixels per inch (ppi), and a higher luminance by about 1.5% in the case of a resolution of 200 ppi, than a pixel not including a division site in the opening. Accordingly, when such pixels with luminance levels different from the others are arranged in one direction, for example, linear display unevenness 26 having a different luminance level from the other portions may be generated in the display region 2 during the halftone display as illustrated in FIG. 5. FIG. 5 is a schematic view illustrating display unevenness caused by different luminance levels of pixels.

As described above, in order to divide the source bus lines into two lines without decreasing the aperture ratio, the source bus lines are preferably divided on the gate bus lines (in the region where the source bus lines overlap the gate bus lines) (for example, the source bus line 6a is divided into two lines on the gate bus line 5b).

Next, the non-preferred position of division sites of the source bus lines in the liquid crystal display device having a double source structure is described below.

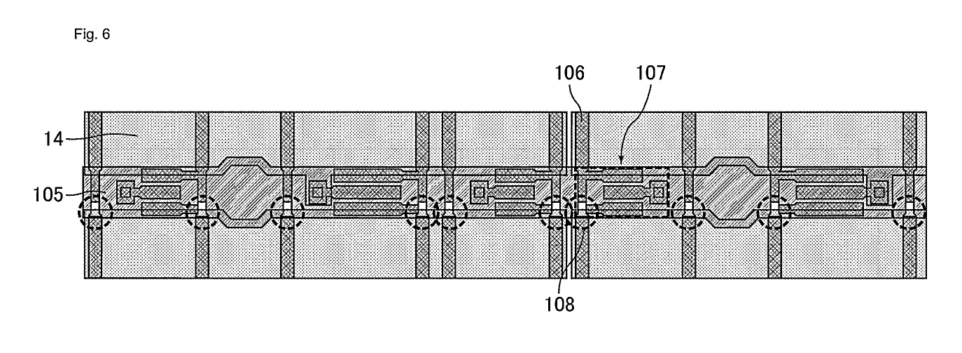

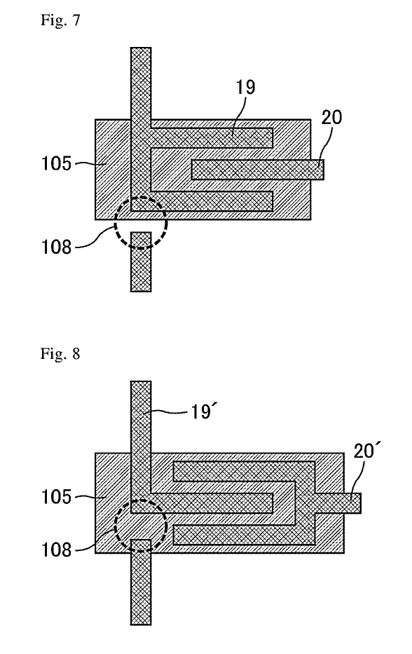

FIG. 6 is a schematic plan view illustrating non-preferred division sites of source bus lines. FIG. 7 is an enlarged schematic plan view of the vicinity of a thin-film transistor element illustrated in FIG. 6. As illustrated in FIG. 6, a source bus line 106 includes a division site 108 in the vicinity of the region where the source bus line 106 overlaps a gate bus line 105 and in the vicinity of a thin-film transistor element 107. In the case where a source electrode 19 and a drain electrode 20 are arranged as illustrated in FIG. 7 and the division site 108 is arranged in the vicinity of the thin-film transistor element 107, the arrangement is not preferred in terms of the display qualities because the division site 108 does not overlap the gate bus line 105. Here, increasing the width of the gate bus line 105 in order to shield the division site 108 from light and improve the display qualities is not preferred because the gate bus line 105 covers the division site 108 to decrease the aperture ratio.

FIG. 8 is a schematic plan view illustrating another non-preferred division site of a source bus line. In the case where a source electrode 19′ and a drain electrode 20′ are arranged as illustrated in FIG. 8, the division site 108 can be arranged to overlap the gate bus line 105. This arrangement, however, is not preferred because the overlapping area of the gate bus line 105 and the drain electrode 20′ increases, and thus the parasitic capacitance between the gate bus line 105 and the drain electrode 20′ (hereinafter, the capacitance is also referred to as Cgd) increases. Usually, in the case of producing the above thin-film transistor array substrate, the Cgd level may change within the display surface of the liquid crystal display panel because of exposure deviation and etching shift amount change, for example. The change (variation) in the Cgd level is correlated to the voltage applied to the liquid crystal layer, thereby causing display unevenness because of the luminance level difference in portions with a Cgd level change and portions without a Cgd level change during the driving. If the Cgd level is high, the amount of change thereof is also large, which gives significant display unevenness because of the luminance level difference. Hence, the Cgd level is preferably low.

As described above, when the source bus line is divided into two lines on the gate bus line, it is not preferred to divide the source bus line in the vicinity of the thin-film transistor elements.

The preferred position of division sites of the source bus lines in the liquid crystal display device having a double source structure is described below.

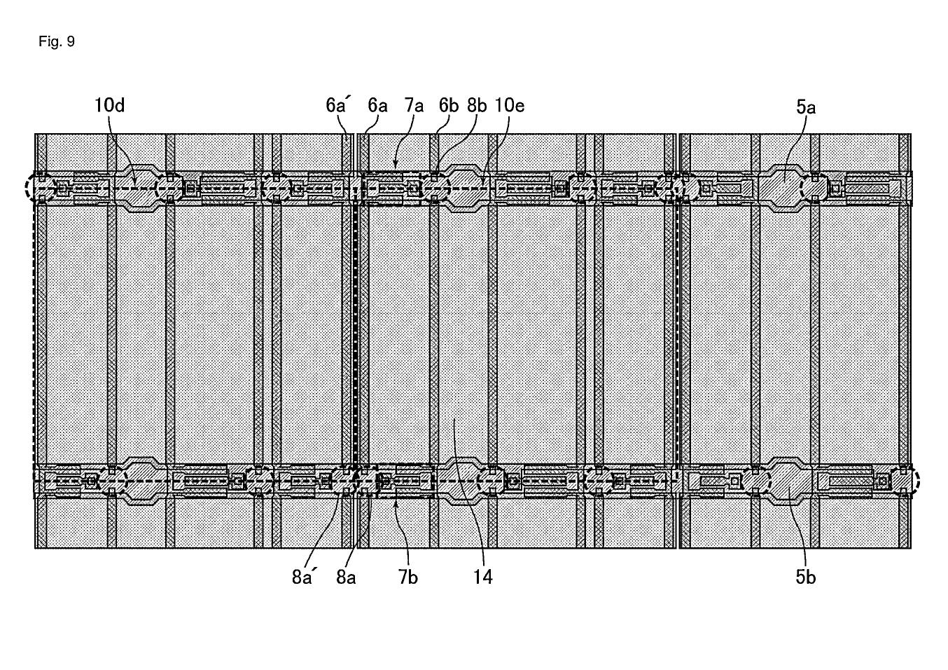

FIG. 9 is a schematic plan view illustrating favorable division sites of source bus lines. The thin-film transistor elements arranged in the up-down direction of FIG. 9 (direction in which the source bus lines 6a and 6b extend) include the thin-film transistor elements 7a and 7b. The thin-film transistor element 7a is connected to the gate bus line 5a and the source bus line 6a. The thin-film transistor element 7b is connected to the gate bus line 5b and the source bus line 6b. Also, the source bus line 6a includes the division site 8a in the region where the source bus line 6a overlaps the gate bus line 5b. The source bus line 6b includes the division site 8b in the region where the source bus line 6b overlaps the gate bus line 5a. Here, the division sites 8a and 8b are regions where the thin-film transistor elements are not arranged, and the division sites 8a and 8b overlap different gate bus lines 5a and 5b. In FIG. 9, a portion indicated by a broken-line circle is a division site of a source bus line.

In the case of a liquid crystal display device having a double source structure, as illustrated in FIG. 9, the arrangements of the thin-film transistor elements are different in pixels 10d and 10e. The adjacent source bus lines 6a and 6a′ arranged between the pixels 10d and 10e include division sites 8a and 8a′ in the regions where the source bus lines 6a and 6a′ overlap the same gate bus line 5b. The source bus line 6a′ corresponds to the first source bus line in the aspects of the present invention. The division site 8a′ corresponds to the first division site in the aspects of the present invention.

As described above, in a liquid crystal display device having a double source structure, the source bus lines (e.g. source bus line 6a) include the division sites (e.g. division site 8a) that divide the source bus lines into two lines, and are in the regions where the source bus lines overlap the gate bus lines (gate bus line 5b). The division sites are preferably arranged to overlap two gate bus lines (for example, preferably, the division site 8a is arranged to overlap the gate bus line 5b, and the division site 8b is arranged to overlap the gate bus line 5a). Thereby, a decrease in the aperture ratio can be sufficiently prevented.

The liquid crystal display device of Embodiment 1 is a vertical alignment ON-ON switching mode liquid crystal display device. The device has a double source structure, and includes the source drivers 4a and 4b arranged at two sides of the display region 2 facing each other. The gate bus line 5b overlapping the division site 8a is adjacent to the gate bus line 5a overlapping the division site 8b. The regions AR1 and AR2 in FIG. 1 include the same number of the gate bus lines.

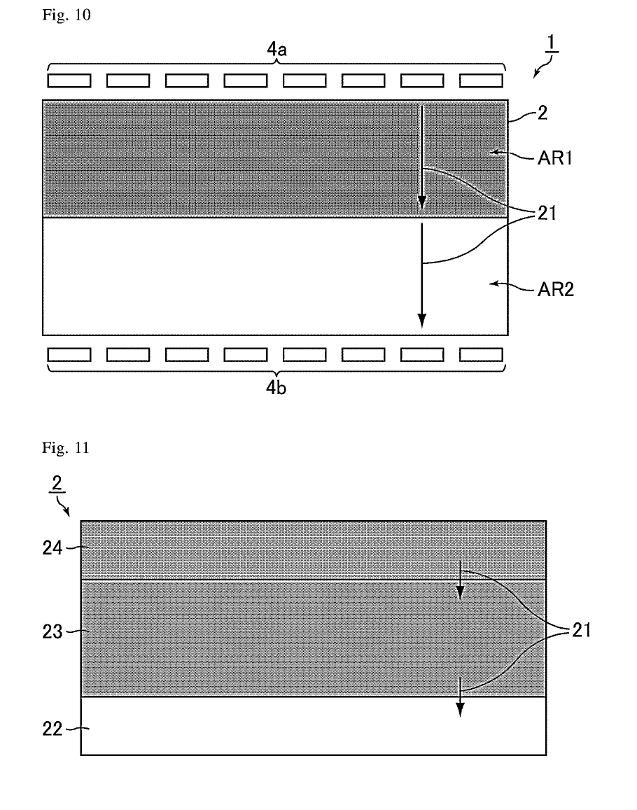

FIG. 10 is a schematic plan view illustrating a liquid crystal display device of Embodiment 1. In the liquid crystal display device of Embodiment 1, the numbers of scanning lines are the same for the regions AR1 and AR2, that is, the number of scanning lines is evenly divided between the respective regions AR1 and AR2, and the writing time can be about doubled, compared to the case of employing a double source structure with one source driver (e.g. FIG. 14). Also, in the liquid crystal display device of Embodiment 1, the number of scanning lines is reduced to ¼ and the writing time can be about quadrupled, compared to the case of employing a single source structure with one source driver.

Hence, the liquid crystal display device of Embodiment 1 is capable of sufficiently preventing a decrease in the aperture ratio and insufficient charging of thin-film transistor elements due to shortening of writing time while achieving high speed driving.

As illustrated in FIG. 10, a scanning direction 21 is the direction from the source driver 4a side (hereinafter, also referred to as the upper side) toward the source driver 4b side (hereinafter, also referred to as the lower side) in the regions AR1 and AR2. Here, the writing time does not change even when the scanning direction 21 is from the upper side to the lower side in the region AR1 and is from the lower side to the upper side in the region AR2. However, in the case that the scanning direction 21 is from the upper side to the lower side in the region AR1 and is from the lower side to the upper side in the region AR2, sites at which the scanning regions are discontinuous (hereinafter, also referred to as scanning joints) are generated for the following reason. Accordingly, the scanning direction 21 is preferably from the upper side to the lower side in both the regions AR1 and AR2.

In the following, scanning joints are described which are generated when the scanning direction 21 is from the upper side to the lower side in the region AR1 and is from the lower side to the upper side in the region AR2.

FIG. 11 is a schematic view illustrating the case where a site at which scanning regions are discontinuous is not generated. FIG. 11 illustrates a case where the scanning direction 21 is from the upper side to the lower side in the regions AR1 and AR2. Here, for example, the scanning direction 21 is from the upper side to the lower side in the regions AR1 and AR2 and the Nth frame image is simultaneously written into the regions AR1 and AR2. In this case, when the (N+1)th frame image is simultaneously written into the regions AR1 and AR2 as in the case of the Nth frame image, the (N+1)th frame image is not yet written into the gate bus line (e.g. the Mth gate bus line) that is included in the region AR1 and closest to the region AR2, and therefore the Nth frame image is still held in the Mth gate bus line. Meanwhile, the (N+1)th frame image is written into the gate bus line (e.g. the (M+1)th gate bus line) that is included in the region AR2 and closest to the region AR1. Accordingly, a joint is generated between the Nth frame image and the (N+1)th frame image, which appears as a discontinuous image joint. Here, the discontinuous image joint described above can be eliminated by storing the image written into the region AR2 in a memory, and then writing the Nth frame image into the region AR2 while writing the (N+1)th frame image into the region AR1. Specifically, as illustrated in FIG. 11, writing of one frame image (e.g. (N−1)th frame image 22) into the entire display region 2 is started, and before the writing is finished, writing of the next frame image (e.g. Nth frame image 23) is started, followed by writing of an image of the frame after the next frame (e.g. (N+1)th frame image 24). In this case, writing appears continuous from the upper side to the lower side of the entire display region 2 (discontinuous sites of scanning directions are not generated). Therefore, since scanning joints are not generated, the scanning direction is preferably from the upper side to the lower side in the regions AR1 and AR2.

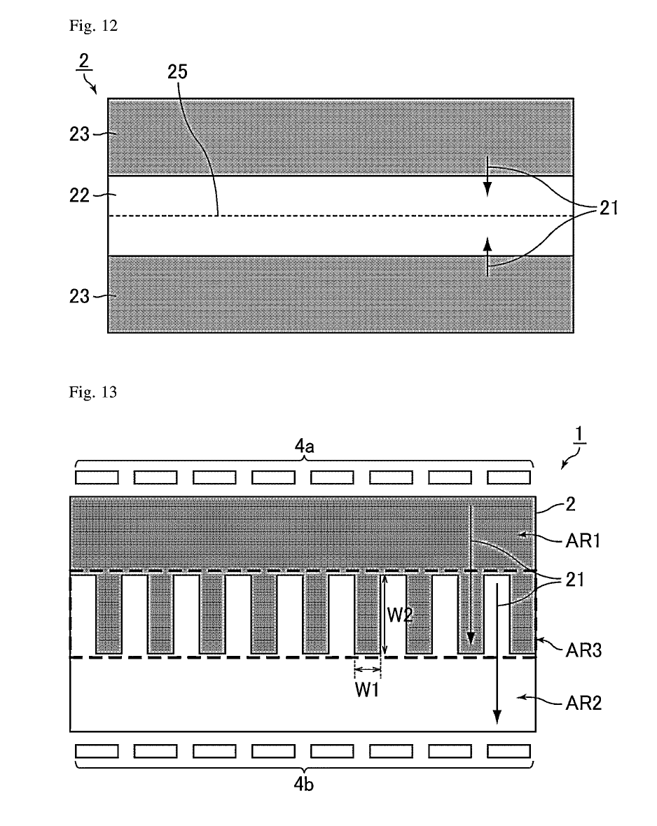

FIG. 12 is a schematic view illustrating the case where a site at which scanning regions are discontinuous is generated. FIG. 12 illustrates the case where the scanning direction 21 is from the upper side to the lower side in the region AR1 and is from the lower side to the upper side in the region AR2. When the scanning direction 21 is from the upper side to the lower side in the region AR1 and is from the lower side to the upper side in the region AR2, discontinuous sites of the scanning directions 21 are generated in the display region 2 as illustrated in FIG. 12, and these sites are recognized as a scanning joint 25.

### Embodiment 2

A liquid crystal display device which can suitably employ a thin-film transistor array substrate of Embodiment 2 (hereinafter, also referred to as the liquid crystal display device of Embodiment 2) is described below. The liquid crystal display device of Embodiment 2 is a vertical alignment ON-ON switching mode liquid crystal display device in which the second gate bus line overlapping the first division site is adjacent to the first gate bus line overlapping the second division site, the first and second division sites are arranged to divide the drive region of the thin-film transistor array substrate into two regions in the first direction, and the divided two regions in the drive region of the thin-film transistor array substrate include different numbers of gate bus lines.

FIG. 1 is a schematic plan view of a liquid crystal display device including the thin-film transistor array substrate of Embodiment 2. The structure of the liquid crystal display device of Embodiment 2 is the same as the structure of the liquid crystal display device of Embodiment 1 except that the numbers of the gate bus lines are different between the regions AR1 and AR2.

In the liquid crystal display device of Embodiment 2, the numbers of scanning lines can be divided into the regions AR1 and AR2 and also the writing time can be further lengthened, compared to a liquid crystal display device having a double source structure with one source driver. In the liquid crystal display device of Embodiment 2, since the numbers of scanning lines are different between the regions AR1 and AR2, the writing times for the regions AR1 and AR2 are changed.

The liquid crystal display device of Embodiment 2 is therefore capable of sufficiently preventing a decrease in the aperture ratio and insufficient charging of thin-film transistor elements due to shortening of writing time while achieving high speed driving.

### Embodiment 3

A liquid crystal display device which can suitably employ a thin-film transistor array substrate of Embodiment 3 (hereinafter, also referred to as the liquid crystal display device of Embodiment 3) is described below. The liquid crystal display device of Embodiment 3 is a vertical alignment ON-ON switching mode liquid crystal display device in which the second gate bus line overlapping the first division site is not adjacent to the first gate bus line overlapping the second division site

FIG. 1 is a schematic plan view of a liquid crystal display device including the thin-film transistor array substrate of Embodiment 3. The structure of the liquid crystal display device of Embodiment 3 is the same as the structure of the liquid crystal display device of Embodiment 1 except that the gate bus line 5b overlapping the division site 8a is not adjacent to the gate bus line 5a overlapping the division site 8b.

FIG. 13 is a schematic plan view illustrating a liquid crystal display device of Embodiment 3. In the liquid crystal display device of Embodiment 3, the numbers of scanning lines can be divided into the regions AR1 and AR2 and also the writing time can be further lengthened, compared to a liquid crystal display device having a double source structure with one source driver. In the liquid crystal display device of Embodiment 3, there is a region (region AR3) in which writing for the region AR1 and writing for the region AR2 are performed. Here, a scanning joint (border between the regions AR1 and AR2) is generated because of the region AR3, but the scanning joint can be made less recognizable depending on the size of the region AR3.

As illustrated in FIG. 13, a width W1 in the right-left direction of FIG. 13 (direction in which the gate bus lines extend) corresponds to the distance between adjacent source bus lines included in the region AR1 (or region AR2), which corresponds to at least one pixel. A width W2 in the up-down direction of FIG. 13 (direction in which the source bus lines extend) corresponds to the distance between the gate bus line 5b overlapping the division site 8a and the gate bus line 5a overlapping the division site 8b, which corresponds to at least one pixel. Here, the case where the width W2 corresponds to one pixel is the case where, for example, the gate bus line 5b overlapping the division site 8a and the gate bus line 5a overlapping the division site 8b are respectively the Nth gate bus line and the (N+2)th gate bus line (where these gate bus lines are arranged with the (N+1)th gate bus line in between).

Here, the width W1 preferably corresponds to one pixel in order to make the scanning joint less recognizable. In this case, the scanning joint has the smallest size, and is less recognizable as a block.

Also, the width W2 preferably corresponds to tens of pixels. In this case, the scanning joint can be blurred, and is thus less recognizable. Here, the width W2 and the writing time are correlated; for example, when the width W2 increases, the writing time is also lengthened. Hence, the width is preferably set to an appropriate width in consideration of the charging time for the thin-film transistor elements.

The liquid crystal display device of Embodiment 3 is therefore capable of sufficiently preventing a decrease in the aperture ratio and insufficient charging of thin-film transistor elements due to shortening of writing time while achieving high speed driving.

### Other Suitable Embodiments

Suitable examples of the liquid crystal display devices of the embodiments other than the ON-ON switching mode liquid crystal display devices include horizontal electric field liquid crystal display devices. When the thin-film transistor array substrate in the horizontal electric field liquid crystal display device has a double-layered electrode structure in which the two layers of electrodes are transparent electrodes formed from a material such as ITO, a high aperture ratio can be achieved. Here, one of the two layers of electrodes is connected to the drain electrode of a thin-film transistor element and receives image signals, and the other receives common signals from the region outside the drive region (outside the active region) of the thin-film transistor array substrate.

### REFERENCE SIGNS LIST

1, 201: Liquid crystal display device
2, 202: Display region
3a, 3b, 203a, 203b: Gate driver
4a, 4b, 204: Source driver
5, 5a, 5b, 105, 205: Gate bus line
6, 6a, 6a′, 6b, 106, 206: Source bus line
7, 7a, 7b, 107, 207: Thin-film transistor element
8a, 8a′, 8b, 108: Division site
9: Electrode
10, 10a, 10b, 10c, 10d, 10e, 210a, 210b, 210c: Pixel
11: Thin-film transistor array substrate
12: Counter substrate
13a, 13b: Glass substrate
14: Lower electrode
15a, 15b: Upper electrode
16: Counter electrode
17: Insulating layer
18: Liquid crystal layer
19, 19′: Source electrode
20, 20′: Drain electrode
21: Scanning direction
22: (N−1)th frame image
23: Nth frame image
24: (N+1)th frame image
25: Scanning joint
26: Display unevenness

1. A thin-film transistor array substrate comprising:
thin-film transistor elements;
first and second gate bus lines extending in a first direction; and
first and second source bus lines extending in a second direction that intersects the first direction,
the thin-film transistor elements arranged in the second direction including a first thin-film transistor element connected to the first gate bus line and the first source bus line, and a second thin-film transistor element connected to the second gate bus line and the second source bus line,
the first source bus line including a first division site that divides the first source bus line into two lines connected to different source drivers, and is in a region where the first source bus line overlaps the second gate bus line,
the second source bus line including a second division site that divides the second source bus line into two lines connected to different source drivers, and is in a region where the second source bus line overlaps the first gate bus line.

2. The thin-film transistor array substrate according to claim 1,
wherein the second gate bus line overlapping the first division site is adjacent to the first gate bus line overlapping the second division site.

3. The thin-film transistor array substrate according to claim 1,
wherein the second gate bus line overlapping the first division site is not adjacent to the first gate bus line overlapping the second division site.

4. The thin-film transistor array substrate according to claim 2,
wherein the first and second division sites are arranged to divide a drive region of the thin-film transistor array substrate into two regions in the first direction, and
the divided two regions in the drive region of the thin-film transistor array substrate include the same number of gate bus lines.

5. The thin-film transistor array substrate according to claim 2,
wherein the first and second division sites are arranged to divide a drive region of the thin-film transistor array substrate into two regions in the first direction, and
the divided two regions in the drive region of the thin-film transistor array substrate include different numbers of gate bus lines.

6. The thin-film transistor array substrate according to claim 1,
wherein the thin-film transistor elements include a semiconductor layer that contains an oxide semiconductor.

7. A liquid crystal display device comprising the thin-film transistor array substrate according to claim 1.

8. The liquid crystal display device according to claim 7,
wherein the liquid crystal display device comprises the thin-film transistor array substrate;
a counter substrate facing the thin-film transistor array substrate; and
a liquid crystal layer sandwiched between the thin-film transistor array substrate and the counter substrate,
the thin-film transistor array substrate including a first electrode, a second electrode, and a third electrode,
the counter substrate including a fourth electrode,
the first electrode and the second electrode constituting a pair of comb-teeth electrodes that include multiple line portions and are arranged on the liquid crystal layer side relative to the third electrode,
the third electrode and the fourth electrode each being a planar electrode.

9. The liquid crystal display device according to claim 8,
wherein the device aligns liquid crystal molecules, contained in the liquid crystal layer, in a direction perpendicular to the main surfaces of the thin-film transistor array substrate and the counter substrate when no voltage is applied.

10. The liquid crystal display device according to claim 8,
wherein the liquid crystal display device is driven by a field sequential system.
